(19) United States
(12) Patent Application Publication
(10) Pub. No.: US 2025/0377756 A1
(43) Pub. Date: Dec. 11, 2025

(54) OUT-OF-PROCESS CUSTOM EFFECTS FOR ELECTRONIC DEVICES

(71) Applicant: Apple Inc., Cupertino, CA (US)

(72) Inventors: Laurence R. WONG, Marina Del Rey, CA (US); Olivier PINON, Santa Clara, CA (US); Yidi ZHU, Mountain View, CA (US)

(21) Appl. No.: 19/080,200

(22) Filed: Mar. 14, 2025

Related U.S. Application Data
(60) Provisional application No. 63/657,976, filed on Jun. 9, 2024.

(51) Int. Cl. G06F 3/0481; G06F 3/01; G06F 3/0484

(52) U.S. Cl. CPC G06F 3/0481; G06F 3/013; G06F 3/0484

(57) ABSTRACT

Out-of-process hit-testing can provide privacy in computer user input systems. In an aspect, an application specifies an effect definition for a preliminary interaction with a UI element of the application, the effect definition including customization parameters to generate the effect. When a user engages in a preliminary interaction with the UI element, the effect is generated and rendered according to the customization parameters, without providing a location of the user input to the application.

### CROSS REFERENCE TO RELATED APPLICATIONS

This application claims the benefit of U.S. Provisional Application No. 63/657,976, entitled “OUT-OF-PROCESS CUSTOM EFFECTS FOR ELECTRONIC DEVICES,” filed Jun. 9, 2024, the entirety of which is incorporated herein by reference.

### TECHNICAL FIELD

This disclosure relates to human-computer interface technologies and computer privacy including, for example, to out-of-process custom effects for electronic devices.

### BACKGROUND

Operating system software generally provides an abstraction layer between user interface hardware and applications that run on top of the operating system. Multiple applications with corresponding user interface windows can be presented on a display managed by an operating system.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example environment for practicing aspects of this disclosure.

FIG. 2 illustrates an example system for providing out-of-process hit-testing, in accordance with aspects of the subject disclosure.

FIGS. 3A and 3B illustrate example methods for providing out-of-process UI services, in accordance with aspects of the subject disclosure.

FIG. 4 illustrates an example use case in which a user input location does not correspond to a UI element.

FIG. 5 illustrates an example use case in which a user input location corresponds to a first UI element.

FIG. 6 illustrates an example use case in which a user input location corresponds to a second UI element.

FIG. 7 illustrates a flow diagram of illustrative operations that may be performed for providing out-of-process hit-testing, in accordance with aspects of the subject disclosure.

FIG. 8A illustrates an example computing device on which aspects of this disclosure may implemented. FIGS. 8B and 8C illustrate flow diagrams for an application process implementing aspects of the disclosure, in accordance with some implementations. FIGS. 8D and 8E illustrate a device diagram and a system diagram, each of which implement aspects of the disclosure, in accordance with some implementations. FIGS. 8F and 8G illustrate a flow for an API calling module and API interface, which may be used in accordance with some implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of this disclosure include techniques for providing increased privacy and/or efficiency in computer user input systems. While any computer input system may benefit from these techniques, systems that are capable of capturing personally identifiable user data, such as extended reality systems that track a user's hand gestures and/or eye gaze location, may particularly benefit from these techniques.

In an aspect of this disclosure, a user input and rendering system may receive and render user input, and may filter the user input available to a computer software application (or “app” herein). User input filtering enables a user's privacy from the application at least by restricting the application's access to the user's filtered input data. In some aspects, a computer user input and rendering system may be more trusted than an application running on the same computer because, for example the user input and rendering system is provided by a trusted operating system vendor, while the application is provided by a less trusted third-party application vendor. Moreover, a user may explicitly provide an authorization to the operating system to access user input information, and may not provide the same authorization to an application, such as a third-party application.

In an aspect, a user may receive rendered feedback of the user's preliminary interactions with a user interface element, such as a button or scroll bar, without making the preliminary interactions available to the application itself. Preliminary interactions with a UI element may include a user's intentional initial interactions with a user interface, such as exploration of the application's interface (for example to discover that a rectangle with a square inside is actually a scroll bar), and preliminary interactions may also include unintentional and even unconscious interactions with UI elements of the application (e.g., as the user's eyes move across a user interface without the user attending to the user interface).

Aspects of this disclosure provide techniques for efficiently retaining privacy of a user's preliminary UI interactions from an application while still providing rendered feedback of the preliminary interactions to the user. Rendered feedback of a preliminary interaction with a UI element might include, for example, default and/or custom effects over a UI element when a user's gaze location control is near or hovers near the UI element.

In an aspect, when it is determined that a user intends to interact with an application (or a UI element of the application), then the user input may be considered no longer to be preliminary (which may be referred to herein as, a confirmed input, an intentional input, and/or an active input), and some user input may be provided to the application. In an aspect, an application may make a declaration or definition of a rendered feedback effect of preliminary interactions with a UI element before preliminary interactions occur, giving the application control over the nature of the preliminary interaction feedback effect, even when the application never learns of a preliminary interaction with its UI elements. The application may provide a declaration or definition of the effect to an operating system or another software component for managing rendering of the preliminary interactions. When the rendering of the effect is managed in a separate operating system process from the application providing the declaration or definition of the effect, the effect is referred to herein as a remote effect or an “out-of-process effect”. As described herein in connection with various examples and/or use cases, a separate operating system process from an application may provide, on behalf of the application, other out-of-process services, without providing information about the out-of-process services to the application (e.g., including out-of-process hit-testing, as described in further detail hereinafter).

Aspects of the subject technology further provide the ability for a developer of the application to specify parameters to customize visual aspects of the effect, such as fade-in, fade-out, shapes, durations, animation curves, and so forth. In some implementations, the effect customizations can be provided through a shader process.

As noted above, aspects of this disclosure may be applied to extended reality systems. A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, user input may include tracking of a person's physical motions, and, in response the XR system may render an adjustment to one or more characteristics of one or more virtual objects simulated in the XR in a manner that comports with at least one law of physics. For example, if a user's hand gesture is rendered in an XR system at a location near but not touching a rendered application UI element, the UI element may be rendered with a glow, shake, resize effect, or jiggle or otherwise indicate a preliminary interaction with that UI element without notifying the application of the preliminary user interaction. The effect (e.g., the glow, shake, resize effect, or jiggle, etc.) can be customized as described herein. In an alternate example, if a user's hand gesture touches or grasps the UI element, it may be determined that the user deliberately intended to interact with the UI element, and the input was an active input, and then the user input indicating a touch or grasp of the UI element may be provided to the application.

Many different types of electronic user input and rendering systems may enable a human user to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Aspects of this disclosure provide rendered confirmation to a user of user engagement with an application user interface prior to providing user input to the application. The user input is protected from the application until the confirmation from the user is provided to engage with the application. A user interface (UI) may be displayed to appear at a location in a physical environment that is remote from a user input device and/or remote from the display device that displays the user interface (e.g., in a three-dimensional XR display environment). For example, physical movement of a mouse input device may be rendered as movement of a mouse cursor on a display at a different physical location (perhaps just a few inches) from the physical mouse. As another example, a gaze cursor may indicate the location of a user's gaze, the location of the user's gaze being remote from one or more eye-facing cameras that are used to determine the gaze location. As another example, a hand motion can be used in conjunction with the user's gaze to move the cursor in relation to an application interface and UI elements within the interface. Similarly, a hand gesture may be rendered as a hand object in a virtual space and presented to a user. Thus, a rendered effect of user input may be rendered or presented to a user at a location that is physically separated from the physical location of the sensor that obtained sensed user input. In a virtual space or other extended reality environment, the user input may also occur at a location that is remote from the display component that displays an application UI and/or a representation of the user's hand to appear to the user to be at a location remote from the display component.

Moreover, a user may move their hand and/or direct their gaze at or near a rendered application user interface without intending to interact with the application UI (e.g., due to normal motion of the user around the physical environment, such as during a conversation with another person unassociated with the electronic device), and/or may perform hand gestures for interaction with one displayed application UI that are not intended to be provided to an application associated with another displayed application UI.

Aspects of the disclosure include receiving, at a system process of an electronic device from an application running on the electronic device, a definition of one or more hover effects, the definition including customizable hover effect parameters. The hover effect parameters can be used by the system process to provide, based on a preliminary interaction with a user interface (UI) element, a custom hover effect without passing any user input to the application. For example, the system can determine that a preliminary interaction intersects with a first UI element of an UI window of the application. The system can determine whether the first UI element has any effects applied thereto, for example, by determining if a hover effect attribute is associated with the first UI element. When the system determines that the first UI element has a hover effect attribute enabled, then parameters defined along with the effect declaration can be used to provide a custom hover effect tied to the first UI element. In some aspects, the parameters can be provided to a shader process and the shader process can utilize the parameter data to generate the hover effect and cause the hover effect to be rendered to a display associated with the system device. In some aspects, an animation for the effect can be generated by providing one or more of an intensity parameter, a beginning duration parameter, an end duration parameter, or one or more animation curves. The animation can be generated, for example, by applying the intensity parameter value to an animation curve, such as a default animation curve or a developer specified animation curve. The animation information and remaining parameters can be used to generate the hover effect and render the hover effect on the display, such as by using the shader process.

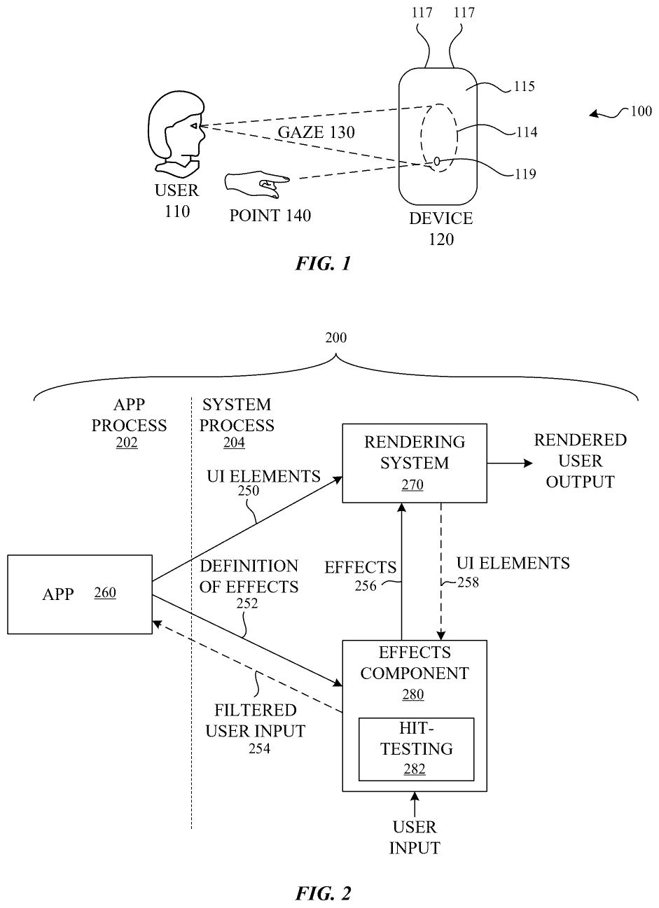

FIG. 1 illustrates an example environment 100 for practicing aspects of this disclosure. In example environment 100, a user 110 interacts with a computing device 120 having a display 115. As shown, the computing device 120 may include one or more speakers, such as speakers 117 (e.g., multiple speakers operable to generate spatialized audio that is perceived, by the user 110 to be emanating from a location, separate from the location of the speakers 117, in the physical environment of the user 110. In one or more examples described herein, user 110 may gaze (e.g., gaze 130) at computing device 120, and the device may sense a gaze location 114 of the user. In one or more examples described herein, user 110 may point or touch (e.g., point 140) at computing device 120, and the device may sense a pointer location 119. In one or more implementations, the user's gaze location and/or point location my constitute a user input(s) to the device.

The computing device 120 may be a smart phone, a tablet device, or a wearable device such as a smart watch or a head mountable portable system, that includes a display system capable of presenting a visualization of an extended reality environment to the user 110. The computing device 120 may be powered with a battery and/or any other power supply incorporated into the computing device 120 and/or coupled to the computing device 120 (e.g., by a cable). In an example, the display system of the computing device 120 provides a stereoscopic presentation of the extended reality environment, enabling a three-dimensional visual display of a rendering of a particular scene, to the user. In one or more implementations, instead of, or in addition to, utilizing the computing device 120 to access an extended reality environment.

The computing device 120 may include one or more cameras (e.g., visible light cameras, infrared cameras, etc.) Further, the computing device 120 may include various sensors that can detect user input including, but not limited to, cameras, image sensors, touch sensors, microphones, inertial measurement units (IMU), heart rate sensors, temperature sensors, Lidar sensors, radar sensors, sonar sensors, GPS sensors, Wi-Fi sensors, near-field communications sensors, etc.) Moreover, the computing device 120 may include hardware elements that can receive user input such as hardware buttons or switches. User input detected by such sensors and/or hardware elements correspond to various input modalities for interacting with virtual content displayed within a given extended reality environment. For example, such input modalities may include, but not limited to, facial tracking, eye tracking (e.g., gaze direction), hand tracking (e.g., point direction), gesture tracking, biometric readings (e.g., heart rate, pulse, pupil dilation, breath, temperature, electroencephalogram, olfactory), recognizing speech or audio (e.g., particular hotwords), and activating buttons or switches, etc. The computing device 120 may also detect and/or classify physical objects in the physical environment of the computing device 120.

In one or more implementations, the computing device 120 may be communicatively coupled to a base device. Such a base device may, in general, include more computing resources and/or available power in comparison with the computing device 120. In an example, the computing device 120 may operate in various modes. For instance, the computing device 120 can operate in a standalone mode independent of any base device.

The computing device 120 may also operate in a wireless tethered mode (e.g., connected via a wireless connection with a base device), working in conjunction with a given base device. The computing device 120 may also work in a connected mode where the computing device 120 is physically connected to a base device (e.g., via a cable or some other physical connector) and may utilize power resources provided by the base device (e.g., where the base device is charging the computing device 120 and/or providing power to the computing device 120 while physically connected).

When the computing device 120 operates in the wireless tethered mode or the connected mode, a least a portion of processing user inputs and/or rendering the extended reality environment may be offloaded to the base device thereby reducing processing burdens on the computing device 120. For instance, in an implementation, the computing device 120 works in conjunction with a base device to generate an extended reality environment including physical and/or virtual objects and/or overlays of virtual objects on physical objects to mimic their look that enables different forms of interaction (e.g., visual, auditory, and/or physical or tactile interaction) between the user and the extended reality environment in a real-time manner. In an example, the computing device 120 provides a rendering of a scene corresponding to the extended reality environment that can be perceived by the user and interacted with in a real-time manner. Additionally, as part of presenting the rendered scene, the computing device 120 may provide sound, and/or haptic or tactile feedback to the user. The content of a given rendered scene may be dependent on available processing capability, network availability and capacity, available battery power, and current system workload.

The computing device 120 may also detect events that have occurred within the scene of the extended reality environment. Examples of such events include detecting a presence of a living being such as a person or a pet, a particular person, entity, or object in the scene.

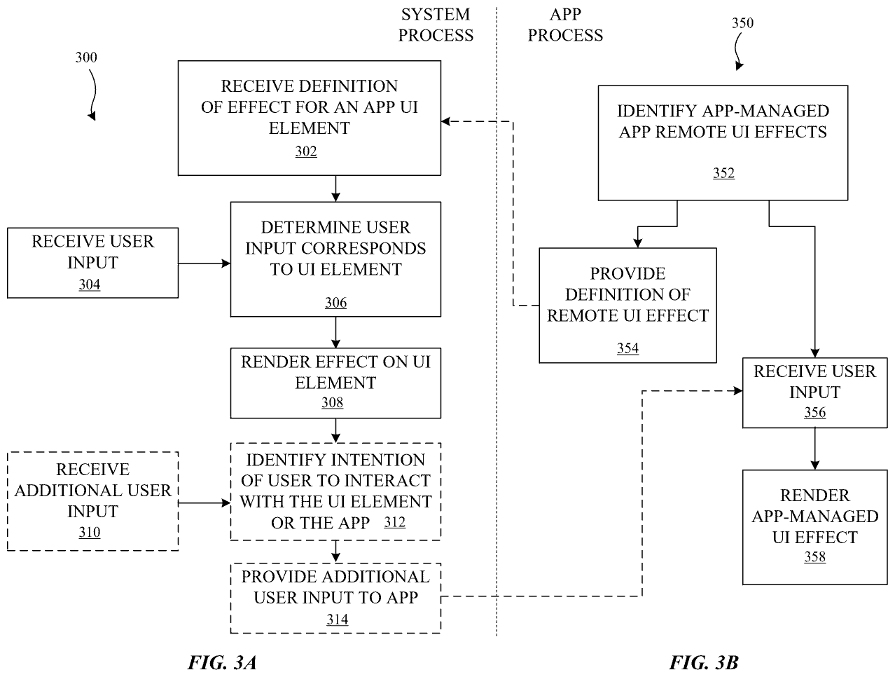

FIG. 2 illustrates an example system 200 for providing out-of-process effects. System 200 may be implemented, for example, on computing device 120. System 200 includes an application (app) process 202 corresponding to an application (app) 260, and a system process 204, including rendering system 270 (e.g., a rendering process) and an effects component 280 (e.g., an effects process). In some aspects, processes 202 and 204 may be separate processes run on a common device, such as computing device 120, or on separate devices. Aspects of the system process 204 (e.g., including the rendering system 270, the effects component 280, and/or hit-testing 282) may be implemented in hardware, software, or a combination thereof.

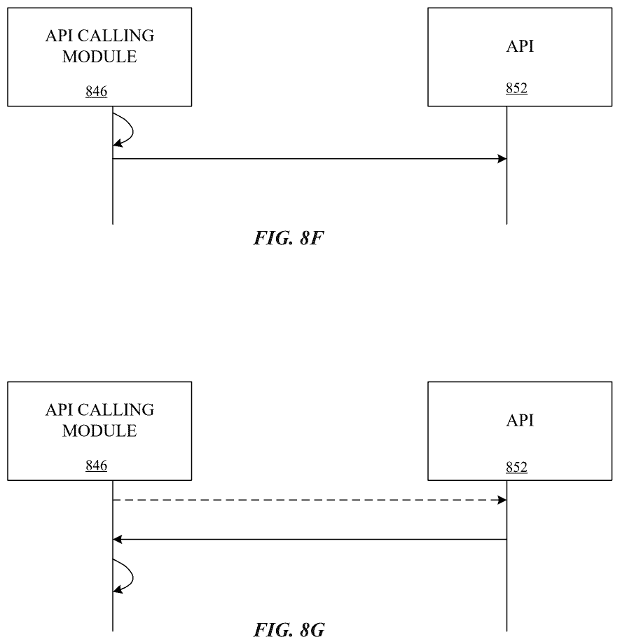

As depicted in FIG. 2, system process 204 includes both rendering system 270 and effects component 280. However, this disclosure is not so limited. For example, rendering system 270 may run in a separate process from the effects component 280, the rendering system 270 and the effects component 280 may be implemented in a common process, or the rendering system 270 and effects component 280 may be further distributed to run in more than two processes, all of which may be separate from app process 202. Similarly, in other aspects, app 260 may be distributed to run in more than one app process. Processes, such as app process 202 and system process 204, may provide security and/or privacy between the processes when running on a common device, such as computing device 120 of FIG. 1 or the computing device of FIG. 8A. For example, app process 202 and system process 204 may operate with different virtual memory spaces as controlled by an operating system and enforced by a processor's memory controller hardware. Separate app and system processes may help prevent app 260 from accessing data inside system process 204. In other aspects, system process 204, rendering system 270 and effects component 280 may include one or more operating system drivers that do not run in a virtual memory space.

Operation of system 200 may include receiving a user input, and outputting a rendered effect as feedback of the user input, and this may be performed outside of the app process 202 and without knowledge of app 260. The user input may correspond to gaze input, for example, and/or point input, and so forth. The rendered effect may include an effect applied to a UI element or triggered by a preliminary interaction with a UI element. App 260 may provide a description of its UI element(s) 250 to rendering system 270, and app 260 may provide a definition of its effects 252 to be rendered in response to future user input. The rendering system 270 can utilize a shader process (or an equivalent thereto) to adjust the rendered output prior to providing it as output to a device. For example, the shader process may provide depth characteristics to various visual elements. Further, for example, in an VR or XR implementation, the shader may apply various adjustments to the rendered output according to various environmental factors, such as lighting. When effects component 280 receives user input corresponding to a definition of effects received from app 260, effects component 280 may cause effects 256 to be rendered by rendering system 270 to a user as output.

In optional aspects of system 200, effects component 280 may learn of a location of a UI element (e.g., a location of a button or scroll bar), for example directly from the app 260 or via optional UI elements 258 message from rendering system 270. In one or more implementations, effects component 280 may then perform optional hit-testing 282 between a current location of a UI element and a current location of a user input. In one or more other implementations, hit-testing 282 may be performed by another system process that is separate from the effects component 280 and that performs hit-testing for multiple different purposes (e.g., for the effects component 280 and other components and/or processes). When a particular user input is identified as being associated with a particular UI element by hit-testing 282 (e.g., by the effects component 280 or another system process of the computing device 120) between a user input and a particular UI element of an app 260, hit-testing 282 may identify a preliminary interaction with the particular UI element of the app 260. When a preliminary interaction is identified, effects 256 may be rendered as user output without notifying app 260 of the user input or the identified interaction. Alternately, when an alternate user input is identified as a confirmed interaction by a user with a UI element, then effects component 280 or another system process may notify app 260 of the confirmed interaction as filtered user input message 254.

The definition of effects 252 may describe a variety of effects that an app instructs the system process 204 to render based on an interaction with one or more UI elements. Each effect defined in the definition of effects 252 may correspond to a certain type of user input interaction with a particular UI element. In aspects, the definition of effects 252 may describe a customized hover effect to be rendered in response to one or more user input interactions with a UI element. For example, the definition of effects 252 may indicate that when a user's gaze is within a certain threshold distance of a UI element, a hover effect can be rendered according to a set of parameters. The threshold distance may be for example, a certain number of pixels, a distance, or the like, and may include zero and may be negative (so that the threshold distance is inset within the UI element). In aspects, the definition of effects 252 may describe a plurality of effects to be rendered in response to a single user input interaction with a single UI element. For example, definition of effects 252 may indicate that when a user's gaze is within a certain threshold distance of a particular button UI element, the button will start to glow to a certain brightness level and/or emit a sound, and when a gaze is in a closer distance range to the button, the UI element may both glow at a brighter level and also wiggle and/or generate a buzzing sound, and when a gaze is in a third closest range (perhaps gazing directly at the button and/or gazing directly at the button for at least a predefined dwell time, such as one second, one half second, one tenth of a second, or a smaller fraction of a second), the user interaction may be identified as a confirmed interaction or an active interaction. Further, each of these plurality of effects may be customized using the processes described herein.

In alternate optional aspects, app 260 may provide effects component 280 with information describing the UI element of the app 260 directly (e.g., instead of the effects component 280 receiving UI information from the rendering system 270). Additionally, instead of hit-testing based on location, hit-testing 282 may more generally determine that a certain user input corresponds to an interaction with a particular user interface element. For example, a user's verbal audio input saying “the red button” may cause the hit-testing 282 to associate that audio input with a red button UI element.

In an aspect, a definition of an effect 252 may be a declarative definition. In this aspect, app 260 may provide all information necessary for a software component outside of app process 202, such as effects component 280, to cause the app's desired effect to be rendered without the app's knowledge or further participation. A declarative definition of an effect may include an identification of a UI element, for example provided by a user interface framework or the operating system, an identification of a triggering user input, and an identification of an effect to be rendered when the triggering user input corresponds to the first UI element. A declarative definition of a customized hover effect may further include parameters related to the hover effect, such as parameters related to a customization of the hover effect used to animate the effect and provided to the renderer to render the effect and/or an API object call that when executed provides parameters related to a customization of the hover effect.

In one or more implementations, the UI element may be vended from one or more files, such as a Universal Scene Description (USDZ) file. In another implementation, the UI element referenced in the app's declarative definition may be provided by the operating system.

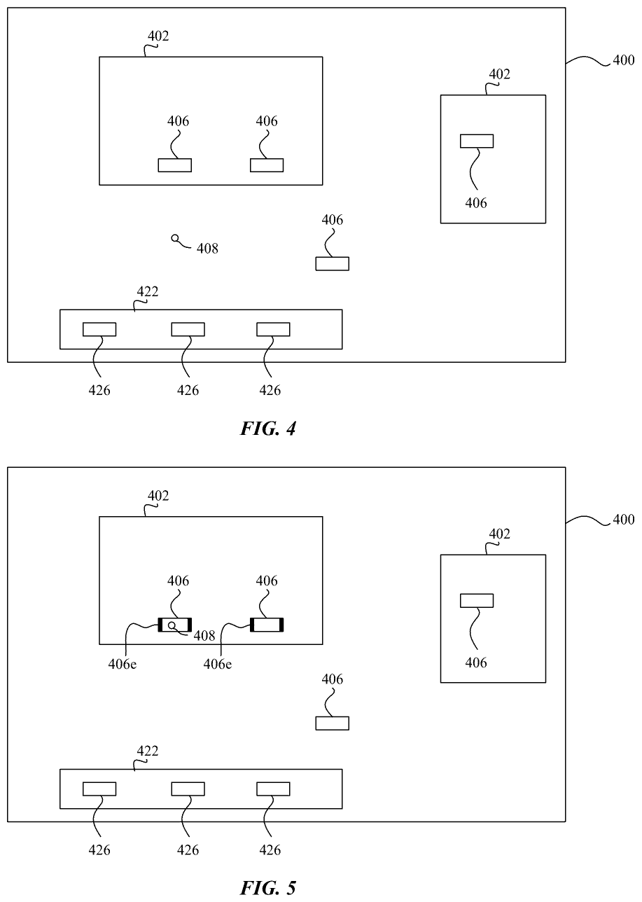

FIG. 3A illustrates an example method for rendering UI effects. As shown, the method of FIG. 3A may include receiving, at a system process 300 (e.g., an implementation of the system process 204 of FIG. 2), one or more definitions of default and/or customized hover effects for a UI element of an app (box 302). User input may be received (box 304) by the system process 300, and when it is determined (e.g., by the system process 300, such as by performing hit-testing 282) that the received user input corresponds to the UI element of the received effect definition (box 306), then the effect may be rendered (e.g., customized and rendered) (e.g., by the system process 300) on the UI element (box 308) according to the effect definition and customization parameters as specified. In an aspect, the operations of FIG. 3A may be performed in a system process 300, separate from an app process 350 (e.g., an implementation of the system process 204) in which the app runs.

The UI element referenced throughout FIGS. 3A and 3B may be part of an app's user interface. For example, the UI element may be defined by the app, and a purpose of the UI element may be to enable a user to interact with the app (after the user's intention to interact with the app is identified). In an aspect, a UI element may include one or more properties, such a location, a size, an orientation, a color, a transparency, or a brightness (as examples) of the UI element, a control style. In one or more implementations, an effect definition may include a modification of one or more properties, such as the location, the size, the orientation, the color, the transparency, or the brightness (as examples) of the UI element. For example, an effect definition for a button UI element may include a lift effect to raise a location property of the button and a brightening effect to increase a brightness property of the button. A customization of the effect definition may include altering a shape of the applied effect, altering an animation curve of the applied effect, altering a duration of the fade-in and/or fade-out of the applied effect, altering an overlay attribute of the applied effect, altering an intensity of the applied effect, and so forth. Furthermore, an app UI element may include predefined “remote states,” where a remote state corresponds to predefined value(s) of the UI element's properties. A remote state of an app's UI element may be considered remote in that, while the app may define the UI element, its properties, and its remote states, only system components in a separate system process (such as rendering system 270 and/or effects component 280) may manage or have knowledge of the UI element's remote state. This may allow a user's preliminary interactions with the UI element to be rendered while remaining private from the app by preventing the app from discovering which remote state the UI element is in at any particular time.

In an aspect, the UI elements referenced throughout FIGS. 3A and 3B may also be obtained directly from the app or from alternate sources, such as the UI frameworks and file formats described above or from the operating system, or such as API calls from the app to the system or from the system to the app. These UI elements provided by alternate sources may act as a portion of an app's user interface (such the user interface of app 260 of FIG. 2). UI elements from alternate sources may have associated properties and “remote states” defined by the alternate source and/or defined by the app using it. For example, even though a UI element may originate from an alternate source, such a UI element may still be managed by the app using it to cause a system process to render remote effects while retaining privacy from the managing app.

In an aspect, UI elements may be specified as a layer tree or as a render tree. For example, application 260 may provide a layer tree or render tree of UI elements to rendering system 270, and application 260 may provide a definition of effects 252 including a layer tree or render tree of UI elements to an operating system or other component managing out-of-process UI effects.

The effect definition (box 302) may be received from a particular app running in an app process 350, and may describe an effect to be rendered on a UI element belonging to that particular app. However, implementations of this disclosure are not so limited. For example, the effect definition received in box 302 may be received indirectly from other sources, the effect definition may be a predetermined effect, or UI element may be a predetermined UI element. In one example, a button UI element may be predefined, and a “lift” effect may be predefined to occur when a gaze or hover user input is determined to correspond to the predefined button effect. In the case of predefined effects and/or predefined UI elements, the received effect definition may include a reference to the predefined elements without fully defining such element. Further, the predefined effects may be customizable through parameters, such as those discussed herein. Further, the customization may be predefined and provided by other sources and the customization may be further customized through the app 260 by adjusting one or more parameters of the customization by effect definition information from the app process 350.

In an aspect, an effect definition may identify an effect to be rendered for a UI element by identifying a remote state (with predefined rendering property values) to be used when user input is determined to correspond to the UI element. In a further aspect, the effect definition may identify an animation to be used when transitioning between predefined remote states.

User input (such as is received in boxes 304 or 310 of FIG. 3) may include one or more different types of input from a user. For example, in addition to user inputs received from user input devices such as a mouse, a keyboard, and/or an audio input device, received user input may also include location and/or orientation tracking of a user's body or body part (such as a fingertip or hand), gesture recognition (such a hand shape, hand motion, and/or a facial expression), or a location of a user's optical gaze (e.g., a gaze location 114). User input may include time or speed measurements, such as a gaze-dwell duration measuring a time duration that a user's gaze remains on or within a certain distance of a particular location or UI element, or hover-dwell measuring a time duration that a user hand or other body part remains within a certain two-dimensional or three-dimensional distance of a particular location or UI element.

In an aspect, UI effects (such as is defined in box 302 and rendered in box 308 of FIG. 3) may include any rendered output a user can sense, including audio, imagery, and/or tactile effects. An example of an audio effect on a UI element may include an audible sound designed to be perceived as emanating from the location of UI element, or a distortion of audio already emanating from the UI element before rendering of the audio effect. As an example of an imagery effect, a UI element may be displayed or otherwise visually presented to a user prior to rendering of the effect, and the rendered effect may change the appearance or location of UI element. For example, a glow effect may cause an existing UI element to glow. A highlight effect may add a new visual cue, such as a circle or check mark, near the location of the UI element. In an aspect, an effect definition may specify an “inverse” rendering effect, in which the specified effect is generally rendered except when a user input corresponds to the UI element. The UI effects can be customized. Although it is contemplated and described herein that imagery (e.g., visual) effects are customized through applying customized parameters, such as shader properties and animations to the effects, audio and/or tactile effects may be customized using similar principles, for example, by providing customization parameters to an audio renderer or by providing customization parameters to a haptic effect renderer.

In an aspect, identifying a correspondence between a user input and a first UI element (box 306) may include identifying a plurality of user interface elements that the first UI element may intersect with, and then determining that the plurality of identified UI elements includes the first UI element. For example, user input may be a gaze location. The system process may perform a hit-testing process (e.g., hit-testing 282) including identifying a list of potential UI elements that the user may be attempting to interact with, such as by identifying all UI elements from all applications that are located within a threshold distance of the gaze location and/or identifying all UI elements with which gaze direction intersects. Similarly, for example, user input may be a hand pointer gesture or positioning of the finger in a pointer position.

An effect definition may include an indication of each UI element to which the effect definition applies. If an effect definition includes an app UI element that is in that list, then the corresponding effect may be rendered on that app UI element. Alternatively, each UI element may include a property of the UI element that indicates that an effect definition is specified for the UI element. In a use case in which the gaze location or hand pointer location intersects with multiple UI elements each having effect definitions, the system process may render the effect on the UI element, among the multiple UI elements, that is displayed to appear closest to the user among the multiple UI elements and/or on the UI element, among the multiple UI elements, with which the gaze location most centrally intersects.

In an aspect, a single effect may be defined for a group of UI elements. For example, when user input correspondence is determined (306) for any of the UI elements in the group, the defined effect may be rendered on all UI elements in the group. For example, the UI elements may be associated with each other in a group such that when an effect is triggered on one of the UI elements of the group, then the effect may be rendered for all UI elements in the group. In another example, user input correspondence in box 306 may be determined by only a subset of the UI elements in the group. The definition of an effect for a group of UI elements may include an indication of a which subset of UI elements in the group to hit-test against. If a user input location (such as a location of a user's gaze or hand gesture) is within a certain proximity (e.g., a predefined distance defined by the system process or in the effects definition) of any element in the indicated subset of UI elements, the effect may be rendered on all UI elements in the group (e.g., unless a foreground UI window or foreground UI element having a foreground control style has been defined and displayed). The effect applied to the group of UI elements may include customization parameters for each one of the effects applied to each one of the UI elements of the group. In some aspects, the customization parameters may be the same for each of the UI elements in the group for the given effect, however, in other aspects, the customization parameters may be individualized for each of the UI elements in the group.

In an aspect, a single effect definition may define a group of rendered effects. When correspondence to the UI element is determined (box 306), the UI element may be rendered with multiple different effects (box 308). For example, an effect definition for a button may include a combination of a lift effect (e.g., a movement of the button in a direction opposite pressing the button), a glow effect (e.g., brighten), and an audio cue (e.g., an audio tone emanating from the button). Further, each of the rendered effects of the group of rendered effects may have customization parameters applied thereto.

In an aspect, an effect definition may combine multiple aspects described above. For example, a single effect definition may include multiple UI elements, multiple effects to render, and/or multiple types of user input that may trigger the rendering of the one or more effects.

In an aspect, only a summary or a subset of user input may be provided to the app (box 314), even after identifying a user's intention to interact with the app (box 312). For example, once a user's gaze-dwell time on an app button is greater than a threshold, the intention to interact with the app may be identified. However, instead of providing the user's gaze location or gaze dwell time to the app, the app may be provided with an indication that the user intended to press the app button without providing the app any knowledge about the user's gaze.

In an aspect, a remote effect definition may specify an animation for rendering when transitioning between remote states. In some implementations, the animation may be an inverse of a fade-in animation and may have the same duration or a different duration than the fade-in animation. In some implementations, the animation may be performed as part of a system established animation curve, while in other implementations, app 260 can provide a customized animation curve that can override a default animation curve. Further, the customized animation curve can be selected based on the values of other parameters so that the applied animation curve can vary depending on state information of the application and/or user interactions, such as, user input location, UI element engagement order, previous UI element engagement, and so forth.

In an aspect, additional user input can be received (box 310). The additional user input can include a physical indication from the user that the user intends to interact with the application. For example, the user may make a pinch gesture, a swiping gesture, a flicking gesture, and so forth, with their hands. Other gestures may be made with a leg, arm, or head. Gestures may include dual hand gestures. The additional user input may also or instead be a mouse click, a vocal signal, a tap, and so forth. The additional user input may be received by the system process and the system process may use the additional user input to identify (box 312) an intention of the user to interact with the UI element or the app. When the system identifies that the user intends to interact with the UI element or the app, then user input can be provided to the app (box 314). The user input that is provided may be an abstraction of the user's input. For example, rather than provide eye gaze input to the app, the location of the input without source-type information may be provided to the app.

FIG. 3B illustrates an example method for rendering UI effects, in accordance with aspects of the subject disclosure. As shown, the method of FIG. 3B may include identifying, by an app process 350, app-managed rendering effect(s) and remote rendering effect(s) (box 352) for corresponding UI elements. A definition of the identified remote rendering effect(s) may be provided, by the app process 350 (box 354), to a remote effect rendering service provider (such as rendering system 270 and/or effects component 280 of FIG. 2) which may use, for example, a shader process to generate the effect according to the customized parameters. User input may be received (box 356), by the app process 350, for a UI element with a corresponding app-managed effect. The app-managed UI effect may be rendered (box 358) by the app process 350 on its corresponding UI element. In one or more implementations, the app-managed UI effect, and/or one or more application functions performable by the app in response to user inputs, may be performed by the app process 350 based on which portions of an application's UI (e.g., which UI element) was interacted with by the user input.

In an aspect, the operations of method of FIG. 3B may be performed in an app process 350, separate from a system process 300 in which the remote/out-of-process UI effects are managed. In another aspect, the method of FIG. 3A may be an example method for providing a remote effect rendering service, and the effect definition provided in box 354 may be received at box 302. In yet another aspect, the additional user input provided in box 314 may be received at box 356.

In one or more aspects, the effect definition provided in box 354 and received at box 302 may include an identification of an effect type provided by the system, such as a button, an overlay, an animation, a label, and so forth. The effect definition may further include customization parameters which may, for example, override attributes associated with the system effect. In some instances, the system may use aspects of the associated UI element, such as size, to fill in some attributes of the effect. The customization parameters can then adjust and/or override the default attributes and system generated attributes. The attributes, for example, can include one or more of a shape attribute, a line attribute, a glow attribute, a shade attribute, a size attribute, a geometry attribute, animation and/or animation curve attributes, transform attributes, translation attributes, mesh attributes, fade-in attributes, fade-out attributes, duration attributes, transparency attributes, reflectiveness attributes, shine attributes, roughness, color, diffuse color, edge color, metallic, opacity, 2D and/or 3D orientation, foreground mix factors, background mix factors, surface patterns, geometry modifications, and so forth. It is also appreciated that additional attributes can be added with system updates which can also be app-specified in the customization parameters. The effects definition may set such attributes through the effects definition format or may provide an API handle for the system to call to retrieve the customization parameters from the application in real time and/or at a time prior to the initiation of the effect.

In one or more aspects, the effects definitions can supply an application-specified effect which is not based on another effect, such as a system supplied effect, but which supplies all relevant parameters for the customized effect. For example, the customization parameters can include any of those attributes specified in the preceding paragraph. In such aspects, a developer, for example, can fully design a customized effect based on manipulating the settings for the available attributes.

In one or more aspects, the system can apply an effect to a virtual object generated in place of a physical object in the environment based on visual sensor input of the physical environment. After generating the virtual object, for example, the effect can, for example, apply a surface texture, label, logo, or color effect to the virtual object without providing user input data to the system related to the preliminary user interaction of the virtual object.

In other aspects, effects for preliminary user interactions may be identified as remote-UI effects, while effects for confirmed user inputs may be identified as app-managed UI effects (box 352). In one or more implementations, app-managed UI effects based on confirmed user inputs may be managed, by the application, based on the location of the user input (e.g., as provided in box 314).

In one or more implementations, delegate-based methods may be provided to dynamically update hover effects based on view state changes of a UI element. In one or more implementations, delegate-based methods may be provided to customize hover effect behaviors dynamically. In one or more implementations, additional customized definitions of remote effects may be provided (e.g., to provide the ability to match effects on multiple views). In one or more implementations, multiple hover effects may be composed or added to a single view (e.g., a single UI element). In one or more implementations, automatic default shapes may be provided for some or all effects, such as for hover effects, focus effects, drag-and-drop effects, context menu previews, etc. In one or more implementations, a shape definition may define a shape as a clip shape (e.g., to automatically set appropriate properties on a given layer, such as by automatically setting a corner radius for a rounded rectangle, or a mask for a custom shape). In one or more implementations, a shape for an effect may be resolved based on one or more device properties (e.g., based on a corner radius of a device display) or based on a container shape (e.g., the shape of a super view in which the shape will be framed). In one or more implementations, hover effects may be defined based on a type of content (e.g., images or video) associated with a UI element and/or based on an input type (e.g., gaze, hand, or pointer-style) of a user input. In one or more implementations, effects may be defined to reveal additional UI information and/or content (e.g., responsive to a gaze at a particular location), to expand a UI element to display more content, and/or to scale up or translate a UI element. In various implementations, out-of-process (e.g., remote) effects and/or application-managed effects may be defined and/or implemented using application programming interfaces (APIs) and/or block-based programming.

The various automatic default shapes described in the preceding paragraph can be customized using data from the application which was provided out-of-process. For example, the various shapes or meshes corresponding to such shapes can be altered by using a shader process to manipulate the shape or mesh according to parameters provided by the app 260. For example, the points of a shape or intersections of a mesh can be altered using the customization parameters.

In various examples described herein, examples of remote UI effects include remote effects (e.g., glow, highlight, lift, wiggle, buzz, etc.) that are generated responsive to identifying a preliminary user input that coincides with a user interface element. In another example use case, one or more remote effects may be generated, by a system process (e.g., the system process 300 described herein) and without providing an indication to the application that the remote effects are being generated, responsive to environmental conditions and/or features.

For example, the system process 300 may generate a lighting effect on a virtual content, such as a rendered three-dimensional (3D) model and/or UI element responsive to identifying a lighting condition in a physical environment of the computing device 120. For example, the system process 300 may receive (e.g., in association with box 354) from the application 260, a request for a lighting effect and customization parameters for the lighting effect for virtual content (e.g., a rendered 3D model and/or a user interface (UI) element) managed by the application 260. The request for the lighting effect may be a request for a system-defined lighting effect or may include a definition (e.g., a declarative definition) of the lighting effect as defined by the application 260. For example, the lighting effect may include brightening, dimming, or otherwise modifying the appearance of various parts of the UI element based on a lighting condition (e.g., a direction and/or a brightness of one or more light sources) in the physical environment. For example, the system process 300 may identify the lighting condition of the physical environment while the virtual content is displayed by the computing device 120. Identifying the lighting condition may include receiving sensor data and/or images (e.g., at box 304, along with or instead of the user input) from one or more cameras and/or sensors. The system process 300 may then render, based on the identified lighting condition and the customization parameters and without providing the lighting condition to the application 260, the lighting effect on the virtual content.

As another example, the system process 300 may generate a mirroring effect on virtual content (e.g., a rendered 3D model and/or a user interface (UI) element), in which the mirroring effect mirrors one or more portions of the physical environment of the computing device 120. For example, the system process 300 may receive (e.g., in association with box 354) from the application 260, a request for a mirroring effect and customization parameters for virtual content managed by the application 260. The request for the mirroring effect may be a request for a system-defined mirroring effect or may include a definition (e.g., a declarative definition) of the mirroring effect as defined by the application 260, which may further include customization parameters for the effect provided by the application 260. For example, the mirroring effect may include displaying an image of a portion of the physical environment so as to appear reflected from a portion of the (e.g., a rendered 3D model and/or a user interface (UI) element) (e.g., a reflective surface or texture on a rendered 3D model and/or UI element). For example, the system process 300 may identify, while the user interface element is displayed by the computing device 120, one or more features of a physical environment of the computing device 120 (e.g., by capturing one or more images of one or more portions of the physical environment). Identifying the one or more features may include receiving sensor data and/or images (e.g., at box 304, along with or instead of the user input) from one or more cameras and/or sensors, and identifying (e.g., at box 306) the one or more features using the sensor data and/or images. The system process 300 may then render, based on the identified one or more features and provided customization parameters for the effect and without providing the one or more features of the physical environment to the application, a reflection of the one or more features of the physical environment on the UI element. Rendering the reflection of the one or more features on the virtual content may include, for example, obtaining an image of a portion of the physical environment, modifying (e.g., rotating, scaling, warping, distorting, or the like) the image based on the position and/or shape of virtual content and/or the reflectivity of the surface of the virtual content, and rendering the modified image over some or all of the virtual content. For example, virtual content in the form of a reflective sphere can be provided by the application 260, and the system process 300 can display a distorted mirror image of the physical environment on the surface of the reflective sphere, without providing any information about the physical environment to the application 260.

In one or more implementations, a system process of an electronic device, such as the computing device 120, may provide one or more other out-of-process services for an application, such as the application 260 (e.g., without providing information about the services to the application, which may help preserve the privacy of the user of the electronic device with respect to the application). For example, in one or more implementations, the system process 300 may provide out-of-process anchoring for one or more applications at the computing device 120.

For example, in one or more implementations, the system process 300 may receive, from an application such as application 260, a request (e.g., in association with box 354) to anchor virtual content (e.g., a rendered 3D model and/or a UI element, such as a UI element for which one or more out-of-process effects can also be provided) of the application to a physical object in a physical environment of the computing device 120. The system process 300 may then anchor (e.g., as part of the rendering at box 308), responsive to the request and without providing information associated with the physical object or the physical environment to the application 260, the virtual content to the physical object. As examples, a physical object that may be requested for anchoring of virtual content of an application may include a table, a wall, a chair, a floor, a horizontal surface, a vertical surface, a hand, a finger, or any other physical object that can be identified by the computing device 120. For example, the anchoring may be provided by the system process without providing transforms, images, sensor data, or any other information describing the physical object or the physical environment or the location of the physical object in the physical environment to the application. For example, the system process may provide the requesting application with only an indication of anchoring success or failure.

In one or more implementations, anchoring the virtual content to the physical object may include identifying, by the system process 300, the physical object in the physical environment (e.g., using sensor data, one or more cameras, and/or computer vision operations); receiving, from the application 260 at the system process 300, rendering information for the virtual content; and rendering, by the system process using the rendering information, the virtual content at a location on a display of the device that corresponds to a location of the physical object in the physical environment (e.g., a location on the display 115 that, when the display 115 is viewed by a user, causes the virtual content to appear to be at the location of the physical object in the physical environment). In various implementations, the rendering information received from the application 260 may include a rendered 3D model, a rendered UI element, or instructions (e.g., a layer tree) for rendering the 3D model or UI element. Anchoring the virtual content to the physical object may also include detecting, by the system process 300 (e.g., using sensors and/or cameras of the computing device 120), motion of the physical object relative to the computing device 120; and modifying, by the system process 300 and without providing information about the motion of the physical object to the application, the rendering of the virtual content to track the motion of the physical object relative to the computing device 120.

In one or more implementations, the system process 300 may provide, to the application 260, a confirmation that the virtual content has been anchored to the physical object, without providing the information associated with the physical object or the physical environment to the application.

In one or more implementations, virtual content that is anchored to a physical object by the system process 300 in an out-of-process anchoring operation may be non-interactive virtual content that includes contextual information about the physical object. In one or more implementations, the virtual content can be rendered in a manner with customization parameters applied to provide a customized effect for the virtual content during a preliminary interaction with the virtual content. In one or more implementations, the physical object may include an image in the physical environment. For example, the image may include a logo (e.g., a logo of a company, a team, or a product). In one or more implementations, the virtual content that is anchored to a physical object by the system process 300 in an out-of-process anchoring operation may include contextual information for the physical object, such as contextual information for a logo (e.g., company information or product information).

For example, in one or more use cases, a request from the application 260 to the system process 300 to anchor virtual content to a physical object in the physical environment of the computing device 120 may include an electronic version of the image. The system process 300 may, responsive to the request including the electronic version of the image: monitor, using the electronic version of the image, the physical environment for the image during operation of the device during a period of time prior to displaying the virtual content. For example, in a use case in which the image includes a logo, the electronic version of the image may include an electronic version of the logo, and the system process 300 may monitor (e.g., using computer vision operations on camera frames captured by the camera(s)) the physical environment for an image that matches (e.g., within a threshold) the electronic version of the image.

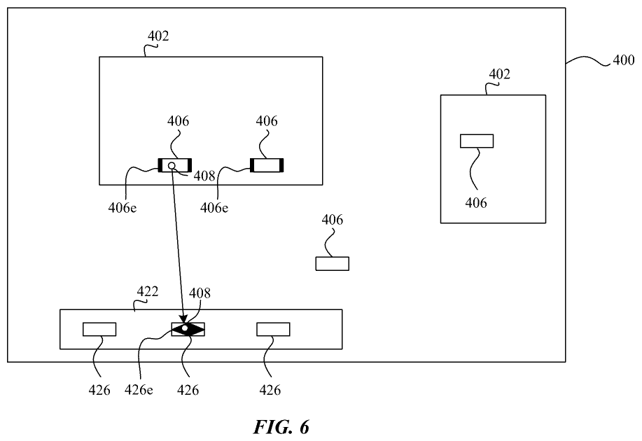

FIG. 4 illustrates an example use case in which one or more UI windows 402 of an application, such as application 260, are displayed in a viewable display area 400 of the computing device 120 (e.g., a viewable area of the display 115 of the computing device 120). For example, the display 115 (see, e.g., FIG. 1) of the computing device 120 may be operable to display, in a viewable display area 400 of the display 115, one or more user interface windows 402 corresponding to an underlying application (e.g., app 260) running at the computing device 120. As shown, the computing device 120 may also display a UI window 422 of another underlying application running at the computing device 120.

FIG. 4 illustrates an example use case in which one or more UI elements 406 are displayed in a viewable display area 400 of the computing device 120. For example, the display 115 (see, e.g., FIG. 1) of the computing device 120 may be operable to display, in a viewable display area 400 of the display 115, one or more user interface windows 402 each corresponding to an underlying application (e.g., app 260) running at the computing device 120. As shown, each of the user interface windows 402 may include one or more user interface elements 406. As examples, the user interface elements 406 may include virtual buttons, virtual switches, virtual lists (e.g., drop-down lists), tabs, scrollbars, application icons, and/or other interactable elements. As shown in FIG. 4, in one or more implementations, a user interface element 406 may be displayed separately from a user interface window 402. As described herein, a system process 300 may render one or more effects for a user interface element 406 when a user input to the computing device 120 corresponds to a UI element 406 (e.g., when the user's gaze location 114 falls within the boundary of the UI element 406 or within a range of the boundary of the UI element 406, and/or when a user's hand or finger (or other pointer) hovers over a location within the boundary of the UI element 406 or within a range of the boundary of the UI element 406, such as for a predetermined amount of time). These effects can be out-of-process effects, defined by the underlying application for the UI element 406, customized according to various customization parameters, and rendered without providing user information (e.g., the location of the user input) to the application. As shown, the computing device 120 may also display a UI window 422 of another underlying application running at the computing device 120.

In the example of FIG. 4, when the location 408 of the user action does not intersect (e.g., as determined using hit testing other methods as described herein) with a UI element 406 or with a UI element 426, no effect is generated based on interaction with any of the UI elements of FIG. 4.

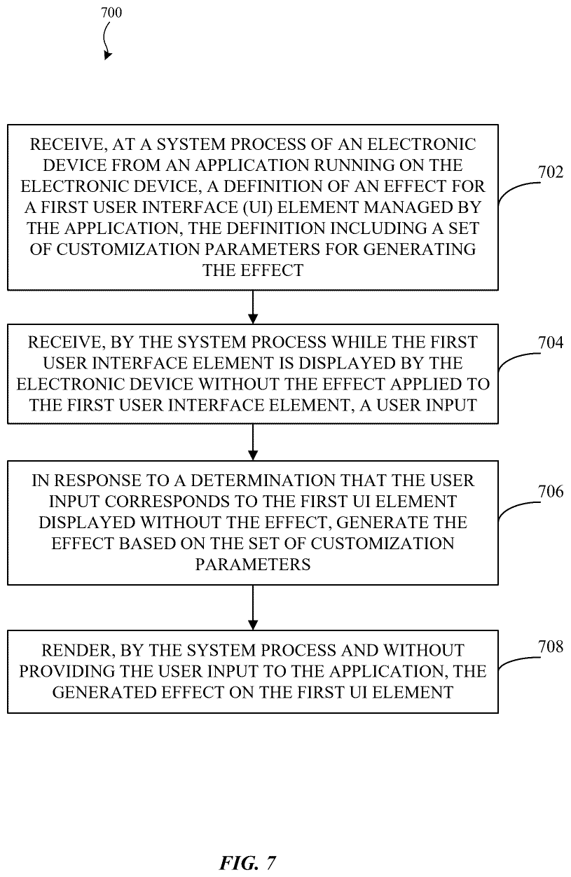

In the example of FIG. 5, when the location 408 of the user action intersects with a first UI element 406 (e.g., as determined using hit testing other methods as described herein), the system may determine whether the first UI element 406 has an effect associated with it. In one example, one property of the first UI element 406 may be a Boolean value that indicates that an effect is associated with the first UI element 406. In another example, the available effects definitions may indicate which elements, such as the first UI element 406 are associated with which effects. If there is an effect associated with the first UI element 406, then the definition of the effect may be determined from the effects definition provided by the app 260 for the first UI element 406. The effects definitions may further provide customization parameters for customizing an output of the effect. An intensity of the effect may be determined based on a multiplier applied to an animation curve associated with the effect, such as a default animation curve or an application-specified (customized) animation curve. The customization parameters and intensity information may be provided to the rendering system (e.g., rendering system 270) for rendering to supply the UI effect 406c.

For example, a shader process of the rendering system can alter an automatically generated effect based on the specified effect to apply the customization parameters. For example, if the specified effect is for a raised button overlay corresponding to the boundaries of the UI element, then a raised button overlay effect may be automatically generated by the system to correspond to the boundaries of the UI element. The rendering system 270, however, can alter the raised button effect according to the customization parameters provided. For example, the raised button effect may specify certain attributes that together define the effect. The customization parameters can override specified attributes while leaving others of the attributes as corresponding to the system generated parameters. The attributes, for example, can correspond to a shape attribute, a line attribute, a glow attribute, a shade attribute, a size attribute, a geometry attribute, animation and/or animation curve attributes, transform attributes, translation attributes, mesh attributes, fade-in attributes, fade-out attributes, duration attributes, transparency attributes, reflectiveness attributes, shine attributes, roughness, color, diffuse color, edge color, metallic, opacity, 2D and/or 3D orientation, foreground mix factors, background mix factors, surface patterns, geometry modifications, and so forth. The customized UI effect 406e, for example, can specify that a solid overlay be produced as two side bars on either side of the first UI element 406.

In other aspects, the effect definition can supply an application-specified effect which is not based on another effect, but which supplies all relevant parameters for the customized effect. For example, the customization parameters can include any of those attributes specified in the preceding paragraph. In such aspects, a developer, for example, can fully design a customized effect based on manipulating the settings for the available attributes. It is also appreciated that additional attributes can be added with system updates which can also be app-specified in the customization parameters.

In other aspects, the system can apply an effect to a virtual object generated in place of a physical object in the environment based on visual sensor input of the physical environment. After generating the virtual object, for example, the effect can, for example, apply a surface texture, label, logo, or color effect to the virtual object without providing user input data to the system related to the preliminary user interaction of the virtual object.

The system can apply the UI effect 406e and specify an intensity of the UI effect 406e (the intensity value corresponding to normalized animation value scaled by a multiplier to control intensity that is provided by the application, such as through an API); specify a position of the UI effect 406e (e.g., corresponding to the world space position of the hit-test or location information for the user input); track the time since the effect started which is the time, e.g., in seconds since the effect was activated; and track the whether the UI effect 406e is active in the system. In some implementations, the time since the effect ended may also be tracked.

In FIG. 5, a use case is also illustrated where an effect applied to the first UI element 406 is applied to each of a group of first UI elements 406 which are specified as having the same customized effect applied to the group when any one of the UI elements in the group are activated by a preliminary user input, such as by the hit-testing resulting from the location 408 of the user input.

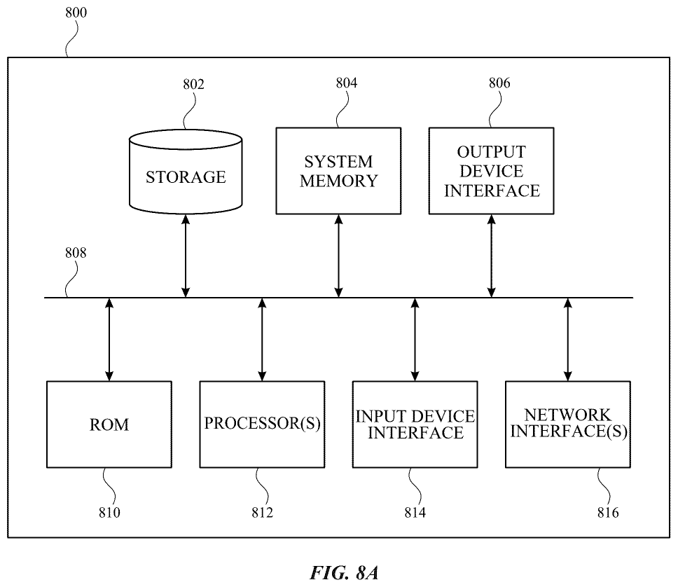

In the example of FIG. 6, while the first customized effect 406e is being applied to the first UI element 406, the location 408 of the user action can be moved to intersect with a second UI element 426 (e.g., as determined using hit testing other methods as described herein) of the UI window 422 (for example, associated with another app 260). As a result, a second customized effect 426e is rendered in a process similar to that described herein, such as in association the UI effect 406e described with respect to FIG. 5. In transitioning the first customized effect 406e from being active to being inactive, the second customized effect 426e can be transitioned from being inactive to being active. During the transitioning each UI effect 406e and UI effect 426e can be active at the same time during an overlap period.

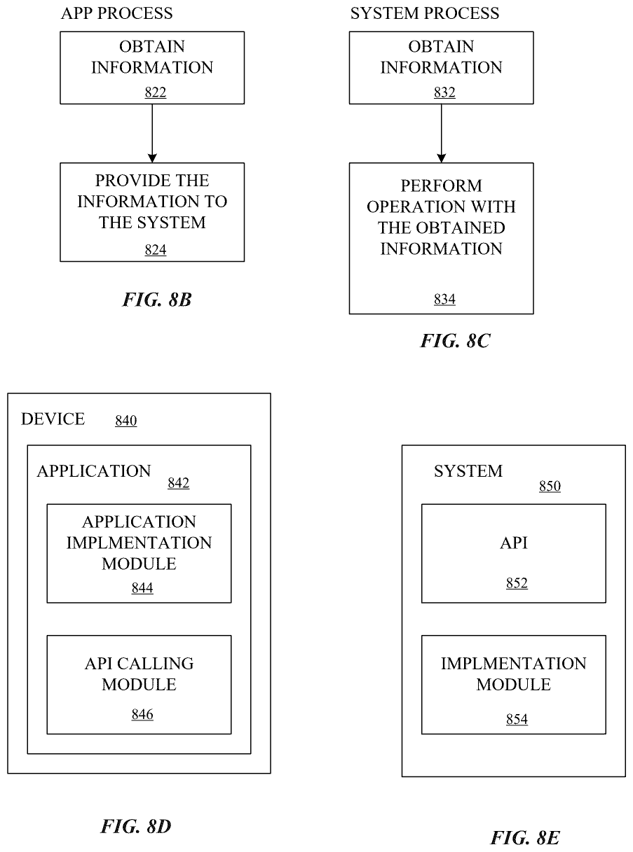

FIG. 7 illustrates an example process 700 for providing out-of-process hit-testing and resizing effects, in accordance with one or more implementations. For explanatory purposes, the process 700 is primarily described herein with reference to the computing device 120 of FIG. 1. However, the process 700 is not limited to the computing device 120 of FIG. 1, and one or more blocks (or operations) of the process 700 may be performed by one or more other components of other suitable devices. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, process 700 may include receiving, at a system process of an electronic device from an application running on the electronic device, a definition of an effect for a first user interface (UI) element managed by the application, the definition including a set of customization parameters for generating the effect. In some implementations, the definition of the effect includes a set of default attributes according to an effect type, where the customization parameters override one or more of the default attributes. In some implementations, the system process is a separate operating system process from an application process in which the application runs. In some implementations, the definition of the effect specifies that the effect is to be applied to multiple UI elements in a group relationship with the first UI element.

At block 704, process 700 may include receiving, by the system process while the first user interface element is displayed by the electronic device without the effect applied to the first user interface element, a user input.

At block 706, process 700 may include in response to a determination that the user input corresponds to the first UI element displayed without the effect, generating the effect based on the set of customization parameters.

At block 708, process 700 may include rendering, by the system process and without providing the user input to the application, the generated effect on the first UI element. In some implementations, the rendering may include displaying the effect at a location corresponding to the user input. In some implementations, the rendering may include applying an animation curve to the generated effect, the animation curve including a fade-in animation portion and a fade-out animation portion. In some implementations, the rendering may include applying a multiplier to the animation curve based on an intensity parameter of the customization parameters. In some implementations, the animation curve may be provided by the application.

In some implementations, the process 700 may further include determining, by the system process, that the user input corresponds to the first user interface element displayed without the effect by: determining, by the system process that a gaze direction of a user of the electronic device intersects the first user interface element displayed without the effect.

In some implementations, the process 700 may further include, in response to the determination that the user input corresponds to the first UI element displayed without the effect, determining that the first UI element has associated with it one or more effects; and in response to determining that the first UI element has associated with it at least one effect, obtaining the definition for each of the one or more effects.

In some implementations, the process 700 may include receiving, at the system process, a second definition of a second effect of a second UI element managed by the application. In some aspects, the second UI element may be displayed concurrently with the first UI element.

As described above, one aspect of the present technology is the gathering and use of data available from specific and legitimate sources for providing out-of-process hit-testing for electronic devices. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing out-of-process hit-testing for electronic devices.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of providing out-of-process hit-testing for electronic devices, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 8A illustrates an example computing device 800 with which aspects of the subject technology may be implemented in accordance with one or more implementations. The computing device 800 can be, and/or can be a part of, any computing device or server for generating the features and processes described above, including but not limited to a laptop computer, a smartphone, a tablet device, a wearable device such as a goggles or glasses, and the like. The computing device 800 may include various types of computer readable media and interfaces for various other types of computer readable media. The computing device 800 includes a permanent storage device 802, a system memory 804 (and/or buffer), an input device interface 806, an output device interface 808, a bus 810, a ROM 812, one or more processing unit(s) 814, one or more network interface(s) 816, and/or subsets and variations thereof.

The bus 810 collectively represents all system, peripheral, and chipset buses that communicatively connect the numerous internal devices of the computing device 800. In one or more implementations, the bus 810 communicatively connects the one or more processing unit(s) 814 with the ROM 812, the system memory 804, and the permanent storage device 802. From these various memory units, the one or more processing unit(s) 814 retrieves instructions to execute and data to process in order to execute the processes of the subject disclosure. The one or more processing unit(s) 814 can be a single processor or a multi-core processor in different implementations.

The ROM 812 stores static data and instructions that are needed by the one or more processing unit(s) 814 and other modules of the computing device 800. The permanent storage device 802, on the other hand, may be a read-and-write memory device. The permanent storage device 802 may be a non-volatile memory unit that stores instructions and data even when the computing device 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random-access memory. The system memory 804 may store any of the instructions and data that one or more processing unit(s) 814 may need at runtime. In one or more implementations, the processes of the subject disclosure are stored in the system memory 804, the permanent storage device 802, and/or the ROM 812. From these various memory units, the one or more processing unit(s) 814 retrieves instructions to execute and data to process in order to execute the processes of one or more implementations.

The bus 810 also connects to the input and output device interfaces 806 and 808. The input device interface 806 enables a user to communicate information and select commands to the computing device 800. Input devices that may be used with the input device interface 806 may include, for example, alphanumeric keyboards and pointing devices (also called “cursor control devices”). The output device interface 808 may enable, for example, the display of images generated by computing device 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8A, the bus 810 also couples the computing device 800 to one or more networks and/or to one or more network nodes through the one or more network interface(s) 816. In this manner, the computing device 800 can be a part of a network of computers (such as a LAN, a wide area network (“WAN”), or an Intranet, or a network of networks, such as the Internet. Any or all components of the computing device 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 842) that, when executed by one or more processing units, control device 840) to perform the method of FIG. 8B, the method of FIG. 8C, and/or one or more other processes and/or methods described herein.

It should be recognized that application 842 (shown in FIG. 8D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 842 is an application that is pre-installed on device 840 at purchase (e.g., a first party application). In other embodiments, application 842 is an application that is provided to device 840 via an operating system update file (e.g., a first party application or a second party application). In some embodiments, application 842 is an application that is provided via an application store. In some embodiments, the application store can be an application store that is pre-installed on device 840 at purchase (e.g., a first party application store). In some embodiments, the application store is a third-party application store (e.g., an application store that is provided by another application store, downloaded via a network, and/or read from a storage device).

Referring to FIG. 8B and FIG. 8F, application 842 obtains information (e.g., 822). In some embodiments, at 822, information is obtained from at least one hardware component of the device 840. In some embodiments, at 822, information is obtained from at least one software module (e.g., set of instructions) of the device 840. In some embodiments, at 822, information is obtained from at least one hardware component external to the device 840 (e.g., a peripheral device, an accessory device, and/or a server). In some embodiments, the information obtained at 822 includes positional information, time information, notification information, user information, environment information, electronic device state information, weather information, media information, historical information, event information, hardware information, and/or motion information. In some embodiments, in response to and/or after obtaining the information at 822, application 842 provides the information to a system (e.g., 824).

In some embodiments, the system (e.g., 850 shown in FIG. 8E) is an operating system hosted on the device 840. In some embodiments, the system (e.g., 850 shown in FIG. 8E) is an external device (e.g., a server, a peripheral device, an accessory, and/or a personal computing device) that includes an operating system.

Referring to FIG. 8C and FIG. 8G, application 842 obtains information (e.g., 832). In some embodiments, the information obtained at 832 includes positional information, time information, notification information, user information, environment information electronic device state information, weather information, media information, historical information, event information, hardware information and/or motion information. In response to and/or after obtaining the information at 832, application 842 performs an operation with the information (e.g., 834). In some embodiments, the operation performed at 834 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 850 based on the information.

In some embodiments, one or more steps of the method of FIG. 8B and/or the method of FIG. 8C is performed in response to a trigger. In some embodiments, the trigger includes detection of an event, a notification received from system 850, a user input, and/or a response to a call to an API provided by system 850.

In some embodiments, the instructions of application 842, when executed, control device 840 to perform the method of FIG. 8B and/or the method of FIG. 8C by calling an application programming interface (API) (e.g., API 852) provided by system 850. In some embodiments, application 842 performs at least a portion of the method of FIG. 8B and/or the method of FIG. 8C without calling API 852.

In some embodiments, one or more steps of the method of FIG. 8B and/or the method of FIG. 8C includes calling an API (e.g., API 852) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8D, device 840 is illustrated. In some embodiments, device 840 is a personal computing device, a smart phone, a smart watch, a fitness tracker, a head mounted display (HMD) device, a media device, a communal device, a speaker, a television, and/or a tablet. Device 840 includes application 842 and an operating system (not shown) (e.g., system 850 shown in FIG. 8E). Application 842 includes application implementation instructions 844 and API-calling instructions 846. System 850 includes API 852 and implementation instructions 854. It should be recognized that device 840, application 842, and/or system 850 can include more, fewer, and/or different components than illustrated in FIGS. 8D and 8E.

In some embodiments, application implementation instructions 844 is a software module that includes a set of one or more computer-readable instructions. In some embodiments, the set of one or more instructions of instructions 844 correspond to one or more operations performed by application 842. For example, when application 842 is a messaging application, application implementation instructions 844 can include operations to receive and send messages. In some embodiments, application implementation instructions 844 communicates with API calling instructions to communicate with system 850 via API 852 (shown in FIG. 8E).

In some embodiments, API-calling instructions 846 is a software module that includes a set of one or more computer-executable instructions.

In some embodiments, implementation instructions 854 is a software module that includes a set of one or more computer-executable instructions.

In some embodiments, API 852 is a software module that includes a set of one or more computer-executable instructions. In some embodiments, API 852 provides an interface that allows a different set of instructions (e.g., API-calling instructions 846) to access and/or use one or more functions, methods, procedures, data structures, classes, and/or other services provided by implementation instructions 854 of system 850. For example, API-calling instructions 846 can access a feature of implementation instructions 854 through one or more API calls or invocations (e.g., embodied by a function or a method call) exposed by API 852 and can pass data and/or control information using one or more parameters via the API calls or invocations. In some embodiments, API 852 allows application 842 to use a service provided by a Software Development Kit (SDK) library. In some embodiments, application 842 incorporates a call to a function or method provided by the SDK library and provided by API 852 or uses data types or objects defined in the SDK library and provided by API 852. In some embodiments, API-calling instructions 846 makes an API call via API 852 to access and use a feature of implementation instructions 854 that is specified by API 852. In such embodiments, implementation instructions 854 can return a value via API 852 to API-calling instructions 846 in response to the API call. The value can report to application 842 the capabilities or state of a hardware component of device 840, including those related to aspects such as input capabilities and state, output capabilities and state, processing capability, power state, storage capacity and state, and/or communications capability. In some embodiments, API 852 is implemented in part by firmware, microcode, or other low level logic that executes in part on the hardware component.

In some embodiments, API 852 allows a developer of API-calling instructions 846 (which can be a third-party developer) to leverage a feature provided by implementation instructions 854. In such embodiments, there can be one or more set of API-calling instructions (e.g., including API-calling instructions 846) that communicate with implementation instructions 854. In some embodiments, API 852 allows multiple sets of API-calling instructions written in different programming languages to communicate with implementation instructions 854 (e.g., API 852 can include features for translating calls and returns between implementation instructions 854 and API-calling instructions 846) while API 852 is implemented in terms of a specific programming language. In some embodiments, API-calling instructions 846 calls APIs from different providers such as a set of APIs from an OS provider, another set of APIs from a plug-in provider, and/or another set of APIs from another provider (e.g., the provider of a software library) or creator of the another set of APIs.

Examples of API 852 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 840. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 854 is a system (e.g., operating system, server system) software module (e.g., a collection of computer-readable instructions) that is constructed to perform an operation in response to receiving an API call via API 852. In some embodiments, implementation instructions 854 is constructed to provide an API response (via API 852) as a result of processing an API call. By way of example, implementation instructions 854 and API-calling instructions 846 can each be any one of an operating system, a library, a device driver, an API, an application program, or other module. It should be understood that implementation instructions 854 and API-calling instructions 846 can be the same or different type of software module from each other. In some embodiments, implementation instructions 854 is embodied at least in part in firmware, microcode, or other hardware logic.

In some embodiments, implementation instructions 854 returns a value through API 852 in response to an API call from API-calling instructions 846. While API 852 defines the syntax and result of an API call (e.g., how to invoke the API call and what the API call does), API 852 might not reveal how implementation instructions 854 accomplishes the function specified by the API call. Various API calls are transferred via the one or more application programming interfaces between API-calling instructions 846 and implementation instructions 854. Transferring the API calls can include issuing, initiating, invoking, calling, receiving, returning, and/or responding to the function calls or messages. In other words, transferring can describe actions by either of API-calling instructions 846 or implementation instructions 854. In some embodiments, a function call or other invocation of API 852 sends and/or receives one or more parameters through a parameter list or other structure.

In some embodiments, implementation instructions 854 provides more than one API, each providing a different view of or with different aspects of functionality implemented by implementation instructions 854. For example, one API of implementation instructions 854 can provide a first set of functions and can be exposed to third party developers, and another API of implementation instructions 854 can be hidden (e.g., not exposed) and provide a subset of the first set of functions and also provide another set of functions, such as testing or debugging functions which are not in the first set of functions. In some embodiments, implementation instructions 854 calls one or more other components via an underlying API and thus be both a set of API calling instructions and a set of implementation instructions. It should be recognized that implementation instructions 854 can include additional functions, methods, classes, data structures, and/or other features that are not specified through API 852 and are not available to API-calling instructions 846. It should also be recognized that API-calling instructions 846 can be on the same system as implementation instructions 854 or can be located remotely and access implementation instructions 854 using API 852 over a network. In some embodiments, implementation instructions 854, API 852, and/or API-calling instructions 846 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, the process 700 (FIG. 7) is performed at a first computer system (as described herein) via a system process (e.g., an operating system process, a server system process) that is different from one or more applications executing and/or installed on the first computer system.

In some embodiments, the process 700 (FIG. 7) is performed at a first computer system (as described herein) by an application (e.g., a trusted application, such as one provided or verified by the manufacturer of the system) that is different from a system process. In some embodiments, the instructions of the application, when executed, control the first computer system to perform process 700 (FIG. 7) by calling an application programming interface (API) provided by the system process. In some embodiments, the application performs at least a portion of process 700 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the process 700 (FIG. 7) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

An API that can be called, for example, can correspond to an API provided receive the UI element effects definitions and customization parameters for the UI element effects for each of the UI elements specified to have effects applied thereto. The application, for example, can call such an API to provide the definition declarations to the system.

As described above, in some embodiments, the application controls the first computer system to perform process 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the API 852 defines a first API call API-calling instructions 846, wherein the definition for the first API call specifies the relevant call parameters according to those variables and elements discussed above.

In some embodiments, the API 852 defines a first API call response that can be provided to the application by API-calling instructions 846, wherein the first API call response provides responsive communications and outputs corresponding to the processes discussed above.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 840) that runs the application. In some embodiments, the set of implementation instructions is included in an electronic device that is separate from the device that runs the application.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, at a system process of an electronic device from an application running on the electronic device, a definition of an effect for a first user interface (UI) element managed by the application, the definition including a set of customization parameters for generating the effect;
receiving, by the system process while the first UI element is displayed by the electronic device without the effect applied to the first UI element, a user input;
in response to a determination that the user input corresponds to the first UI element displayed without the effect, generating the effect based on the set of customization parameters; and
rendering, by the system process and without providing the user input to the application, the generated effect on the first UI element.

2. The method of claim 1, wherein the system process is a separate operating system process from an application process corresponding to the running application.

3. The method of claim 1, wherein determining, by the system process, that the user input corresponds to the first UI element displayed without the effect comprises:
determining, by the system process that a gaze direction of a user of the electronic device intersects the first UI element displayed without the effect.

4. The method of claim 1, wherein the definition of the effect includes a set of default attributes according to an effect type, wherein the customization parameters override one or more of the default attributes.

5. The method of claim 1, further comprising:
in response to the determination that the user input corresponds to the first UI element displayed without the effect, determining that the first UI element has associated with it one or more effects; and
in response to determining that the first UI element has associated with it the one or more effects, obtaining the definition for each of the one or more effects.

6. The method of claim 1, wherein the rendering comprises:
displaying the effect at a location corresponding to the user input.

7. The method of claim 1, wherein the rendering further comprises:
applying an animation curve to the generated effect, the animation curve including a fade-in animation portion and a fade-out animation portion.

8. The method of claim 7, wherein the rendering further comprises:
applying a multiplier to the animation curve based on an intensity parameter of the customization parameters.

9. The method of claim 7, wherein the animation curve is provided by the application.

10. The method of claim 1, wherein the definition of the effect specifies that the effect is to be applied to multiple UI elements in a group relationship with the first UI element.

11. The method of claim 1, further comprising:
receiving, at the system process, a second definition of a second effect of a second UI element managed by the application.

12. The method of claim 11, wherein the second UI element is displayed concurrently with the first UI element.

13. An electronic device comprising:
one or more processors; and
a computer-readable medium, wherein the one or more processors are configured to perform operations comprising:
receiving, at a system process of the electronic device from an application running on the electronic device, a definition of an effect for a first user interface (UI) element managed by the application, the definition including a set of customization parameters for generating the effect;
receiving, by the system process while the first UI element is displayed by the electronic device without the effect applied to the first UI element, a user input;
in response to a determination that the user input corresponds to the first UI element displayed without the effect, generating the effect based on the set of customization parameters; and
rendering, by the system process and without providing the user input to the application, the generated effect on the first UI element.

14. The electronic device of claim 13, wherein determining, by the system process, that the user input corresponds to the first UI element displayed without the effect comprises:
determining, by the system process, that a gaze direction of a user of the electronic device intersects the first UI element displayed without the effect.

15. The electronic device of claim 13, wherein the definition of the effect includes a set of default attributes according to an effect type, wherein the customization parameters override one or more of the default attributes.

16. The electronic device of claim 13, wherein the operations further comprise:
in response to the determination that the user input corresponds to the first UI element displayed without the effect, determining that the first UI element has associated with it one or more effects; and
in response to determining that the first UI element has associated with it the one or more effects, obtaining the definition for each of the one or more effects.

17. The electronic device of claim 13, wherein the rendering further comprises:
applying an animation curve to the generated effect, the animation curve including a fade-in animation portion and a fade-out animation portion; and
applying a multiplier to the animation curve based on an intensity parameter of the customization parameters, wherein the animation curve is provided by the application.

18. The electronic device of claim 13, wherein the definition of the effect specifies that the effect is to be applied to multiple UI elements in a group relationship with the first UI element.

19. The electronic device of claim 13, wherein the operations further comprise:
receiving, at the system process, a second definition of a second effect of a second UI element managed by the application, wherein the second UI element is displayed concurrently with the first UI element.

20. A non-transitory computer-readable medium storing instructions thereon, which when executed by one or more processors, cause the one or more processors to perform operations comprising:
receiving, at a system process of an electronic device from an application running on the electronic device, a definition of an effect for a first user interface (UI) element managed by the application, the definition including a set of customization parameters for generating the effect;
receiving, by the system process while the first UI element is displayed by the electronic device without the effect applied to the first UI element, a user input;
in response to a determination that the user input corresponds to the first UI element displayed without the effect, generating the effect based on the set of customization parameters; and
rendering, by the system process and without providing the user input to the application, the generated effect on the first UI element.
